(19) United States
(12) Patent Application Publication
(10) Pub. No.: US 2011/0270489 A1
(43) Pub. Date: Nov. 3, 2011

(54) Vehicle Electrical System

(76) Inventors: Martin Gustmann, Hochdorf (DE); Manfred Stahl, Stuttgart (DE)

(21) Appl. No.: 13/054,353

(22) PCT Filed: Jun. 10, 2009
(86) PCT No.: PCT/EP2009/057136

§ 371 Date: Apr. 4, 2011

(30) Foreign Application Priority Data
Jul. 29, 2008 (DE) 102008040810.7

(51) Int. Cl. G06F 7/00; B60L 1/00; B60K 6/20

(52) U.S. Cl. 701/36; 180/65.21; 307/10.1

(57) ABSTRACT

A vehicle electrical system for a motor vehicle having a vehicle electrical system with electrical consumers connected to it. The vehicle electrical system also has electrical energy generation devices and at least one energy accumulator connected to it. The energy accumulator is being able to be separated from the vehicle electrical system via a switching device. At least one switching device monitor is provided, which checks the operating state of the switching device.

### BACKGROUND INFORMATION

The present invention relates to a vehicle electrical system for a motor vehicle equipped with at least one vehicle electrical system which has at least one electrical consumer connected to it, and/or which has at least one device for producing electrical energy connected to it, as well as at least one energy accumulator, the energy accumulator being able to be separated from the vehicle electrical system via a switching device. In addition, the present invention relates to a motor vehicle, especially a hybrid motor vehicle, having at least one vehicle electrical system. Moreover, the present invention relates to a method for checking the operating state of an electrical switching device, which connects an electrical energy accumulator to a vehicle electrical system in a reversible manner.

For safety considerations and reasons of better storability of electrical energy, batteries (accumulators), which are electrically connected to the vehicle power supply via so-called contactors in a normal operating state, are finding increasing use in motor vehicles. Electrical consumers as well as electrical energy generators, usually electrical generators, are connected to the vehicle electrical system in a conventional manner. In a standstill operating state, however, the contactors are open, so that the battery is electrically separated from the vehicle power supply (it being possible for individual, selected consumers to remain connected to the vehicle battery, e.g., the vehicle clock and the like). This makes it possible to protect the vehicle battery from being discharged by creeping currents. However, the contactor may also be opened in case of an accident in order to thereby prevent the production of short-circuits in an effective manner.

Such contactors are used especially frequently in so-called high-voltage vehicle electrical systems. Such high-voltage vehicle electrical systems are operated at an increased voltage in comparison with the normal vehicle electrical voltage of 12 Volt or 24 Volt, e.g., at 42 Volt or 48 Volt. High-voltage vehicle electrical systems of this type are increasingly used for operating especially high-power electrical components. For example, these components may be electrical heating devices or else also drive motors or recuperation generators in hybrid vehicles. Because of the advancing technical developments in the motor vehicle construction, such electrical high-power components and high-voltage vehicle electrical systems that go along with this development are used to an increasing extent.

If a contactor is switched under load, in particular a contactor used in a high-voltage vehicle electrical system, may happen that the contacts stick. To prevent such sticking of the contactors, control electronics are employed in an attempt to minimize the electrical current flowing via the contactors, prior to allowing the contactor to open. However, in some cases the switching of the contactor also under a higher load is unavoidable.

Defective or faulty hardware or software may likewise result in sticking of the contactors. Furthermore, ageing, constructive flaws or manufacturing faults cause faults in contactors as well.

In order to increase the functioning and the reliability of a motor vehicle provided with contactors, it should be possible to detect any defects in the contactor in a reliable manner.

Conventional contactors still have deficits in this regard.

### SUMMARY

According to an example embodiment of the present invention, at least one switching device monitor for a vehicle electrical system for a motor vehicle equipped with at least one vehicle electrical system is provided having at least one electrical consumer connected to it and/or at least one energy generation device connected to it, and also having at least one energy accumulator, the energy accumulator being separable from the vehicle electrical system via a switching device, and the switching device monitor checking the operating state of the switching device. The switching device may be an electrical switch, in particular, which is able to be opened or closed. Specifically, it may be a contactor, which preferably is configured for high electrical currents and/or for high electrical vehicle voltages. The energy accumulator may be an accumulator device which, in particular, is able to store electrical energy temporarily. The temporary storage of electrical energy may be achieved through physical and/or chemical means, e.g., by accumulators (such as lead accumulators, nickel-cadmium accumulators, nickel metal hydride accumulators, lithium-ion accumulators, lithium polymer accumulators or capacitors (such as gold cap capacitors). It is also possible to implement the temporary storage of the electrical energy by mechanical means, e.g., by accelerating or decelerating a flywheel. At least one electrical consumer or at least one electrical energy generation device is connected to the actual vehicle electrical system. Preferably, at least one electrical consumer and at least one electrical energy generation device are provided, in particular. However, a plurality of electrical consumers and possibly also a plurality of electrical energy generation devices may be provided.

One or a plurality of device(s) periodically functioning as electrical consumer and periodically as electrical energy generation device may also be provided. The switching device monitor, which checks the operating state of the switching device, is implementable as an electronic circuit, for example, such as a one-plate computer. The electronic switching device monitor may be designed as separate device or be integrated into a component, e.g., the switching device. It is also possible to integrate the switching device monitor in an electronic control device that is available anyway, by providing it with an additional switching logic or with additional logic instructions, for instance. The switching device monitor preferably is based on a check of the interplay between a plurality of components and their mutual influencing. This makes it possible to obtain an especially reliable statement about the operating state of the switching device.

At least one of the electrical consumers may be an electrical drive motor. Preferably, the electrical consumer (i.e., the electrical drive motor) may be operated as electrical generator intermittently. Such an intermittent operation of an electrical motor as electrical generator is common in hybrid drive system for motor vehicles, for instance. Electrical drive motors require high electrical outputs for their operation, and consequently high voltages and/or high electrical currents. In this regard, the provision of a high-voltage vehicle electrical system is usually unavoidable in motor vehicles. However, for reasons related to safety as well as operating reliability and functionality, such a high-voltage vehicle electrical system should be realized by an energy accumulator which is able to be separated by a switching device. In hybrid motor vehicles, the operation of the electrical drive motor as electrical generator usually takes place during the so-called recuperation operation, in which the kinetic energy of the vehicle is transformed into electrical energy in order to be temporarily stored in the energy accumulator. Here, too, high electrical voltages and/or high electrical currents usually occur for function-related reasons.

It may also be useful if at least one electrical energy generation device is developed as electrical generator which may be driven by an internal combustion engine, in particular. Such a development of energy generation devices is also often encountered in hybrid motor vehicles. Using an electrical generator, mechanical or chemical energy contained in the fuel is able to be converted into electrical energy. In a hybrid motor vehicle equipped with a dedicated electrical generator, for example, it is possible to convert mechanical power produced by the internal combustion engine into electrical energy largely independently of the instantaneous operating state of the hybrid motor vehicle. This, for example, allows the internal combustion engine to be operated in a particularly fuel-efficient speed or torque range especially frequently.

A useful development may result if the switching device is able to assume at least two switching states, preferably three or more switching states. The two switching states (or, if a plurality of switching states is provided, in two of these switching states), may be, in particular, an open switch state (infinite electrical resistance) and a closed switch state (electrical resistance substantially equals zero). The mentioned switch states may be advantageous in particular insofar as they allow the occurring electrical losses to be kept to a minimum. However, it may also be useful to loop an electrical resistor into the connection between energy accumulator and vehicle electrical system in at least one of the switching states. This may be specifically a third, fourth, etc. switching state. For in certain operating states such a series resistor may be useful for protecting the energy accumulator. In this way the operational reliability of the vehicle electrical system may be improved even further.

It may be useful if at least one switching device monitor is developed as performance test device and preferably includes performance test sources. Knowing the electrical loading of the vehicle electrical system by the electrical consumer(s) allows the switching device monitor to check, via the voltage drop occurring at the switching device, for instance, which operating state the switching device has currently assumed. If, for example, a high voltage drop along the switching device is determined by the switching device monitor when one or a plurality of electrical consumer(s) is switched on, notwithstanding the fact that the switching device is controlled (switched) to “closed”, then it may be assumed that the switching device is defective, for instance due to corroded switch contact surfaces. The instantaneous operating state is able to be determined in an especially precise manner if the consumer behavior of the electrical consumers is known in particularly great detail. A special performance test load, which is connected as sole consumer or which is connected in addition to the currently operated consumers, may be provided as load to the vehicle electrical system in order to increase the checking accuracy of the switching device monitor. In this context it makes sense, of course, if the duration for which the performance test load is connected to the vehicle electrical system is so low that the consumption behavior of the other consumers possibly also connected to the vehicle electrical system does change at all or changes as little as possible. Specifically, an electrical resistor connectable to ground, such as the brake chopper of an electrical rectifier, is possible as performance test load.

However, it is also possible to implement at least one switching device monitor as supply test device and preferably provide it with supply test sources. This, too, makes it possible to determine the operating state of the switching device in a reliable manner. A supply test may suggest itself in particular when the energy accumulator has only a low charge level. At such a low charge level of the energy accumulator, a performance test could possibly not be carried out due to insufficient electrical energy. It may even be the case that the performance test at a low charge state of the energy accumulator could lead to damage of the energy accumulator. The supply test sources may preferably be energy sources whose electrical energy release behavior is known as precisely as possible and/or is reproducible as precisely as possible.

It is also possible that at least one switching device monitor has at least one measuring device selected from the group that encompasses current measuring devices, voltage measuring devices, voltage differential measuring devices, voltage characteristic measuring devices and current characteristic measuring devices. For instance, the current measuring device may be a measuring device which measures the electrical current (i.e., the battery current) flowing through the switching device. The measurement itself is able to be implemented using conventional methods. The voltage measuring device may be a measuring device which measures the voltage prevailing in the vehicle electrical system, the voltage applied at the energy accumulator, the voltage applied at an electrical consumer, and/or the voltage applied at an electrical energy generation device. The voltages determined in this manner may also be compared to each other in the switching device monitor. A voltage differential measuring device could be a measuring device that measures a voltage drop at, or a voltage differential between, two defined points. The points may be the input and the output side of the switching device, for example. A voltage characteristic measuring device could be a measuring device which determines the temporal characteristic or the temporal development of a voltage applied at a specific point. Accordingly, it is also possible to provide a current characteristic measuring component, which determines the temporal characteristic of an electrical current passing through a specific point. Of course, a plurality of measured values from different measuring devices may also be combined in the switching device monitor in order to arrive at an even more precise prediction or at a more rapid determination of the operating state of the switching device.

Another meaningful development of the vehicle electrical system may result if the vehicle electrical system has at least one second vehicle electrical system, which preferably has a different nominal voltage. For example, the vehicle electrical system may have a high-voltage vehicle electrical system that uses a vehicle system voltage of 42 Volt or 48 Volt, which is suitable for electrical high-power consumers, in particular. The additional, second vehicle electrical system may be operated at a voltage of 12 Volt or 24 Volt, for instance. This makes it possible to utilize already existing motor vehicle components in an especially uncomplicated manner. For instance, a particularly rapid acceptance of the provided vehicle electrical system is able to be promoted in this manner. Preferably, the vehicle electrical system is equipped with the switching device that uses the higher vehicle system voltage. However, it is also possible for the second vehicle electrical system (or the additional vehicle electrical systems) to be provided with a switching device.

In addition, a motor vehicle is provided, in particular a hybrid motor vehicle, that is equipped with at least one vehicle electrical system having the afore-described design. An appropriately designed motor vehicle then provides the above-described properties and advantages in an analogous manner.

Furthermore, an example method is provided for checking the operating state of an electrical switching device which connects an electrical energy accumulator to a vehicle electrical system in a reversible manner, such that the operating state of the switching device is determined by measuring the temporal characteristic of at least a voltage, by measuring the temporal characteristic of at least a current, by measuring the electrical current flowing through the switching device, and/or by measuring a voltage differential across the switching device. It is also possible to further develop the provided method within the meaning of the afore-described development options. In analogous manner, it then has the characteristics and advantages described above in connection with the vehicle electrical system.

### BRIEF DESCRIPTION OF THE DRAWINGS

Below, the present invention is explained in greater detail on the basis of exemplary embodiments with reference to the figures.

FIG. 1 shows an exemplary embodiment of a high-voltage vehicle electrical system of a hybrid vehicle, having a closed contactor.

FIG. 2 shows different measuring curves of the high-voltage vehicle electrical system shown in FIG. 1, with a faulty contactor.

FIG. 3 shows the exemplary embodiment of a high-voltage vehicle electrical system of a hybrid vehicle as shown in FIG. 1, with a closed contactor.

FIG. 4 shows different measuring curves of the high-voltage vehicle electrical system shown in FIG. 3, with a faulty contactor.

### DETAILED DESCRIPTION OF EXAMPLE EMBODIMENTS

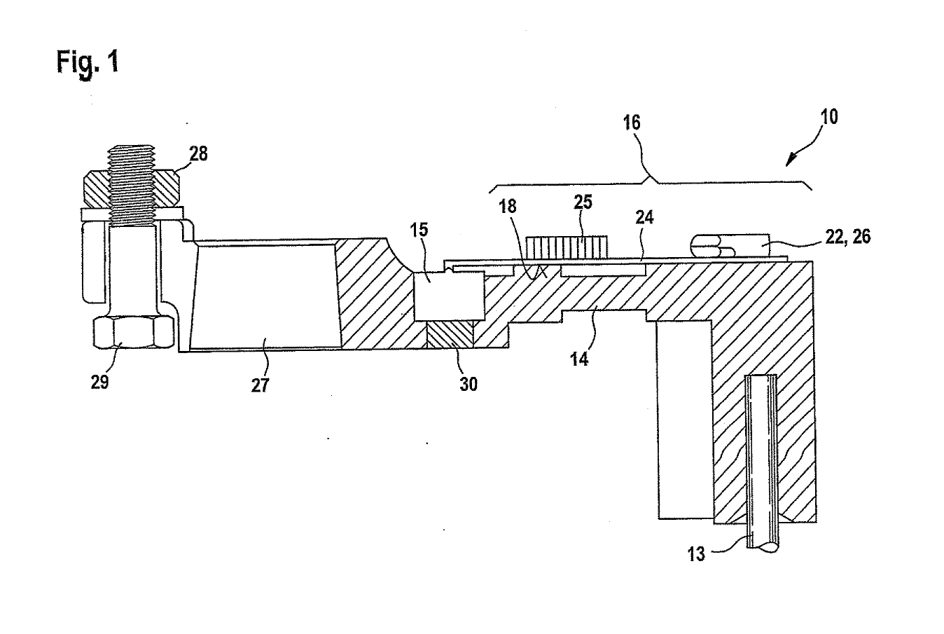

FIG. 1 shows vehicle electrical system 1 for a hybrid motor vehicle 15 in a schematic circuit diagram. Vehicle electrical system 1 has a high-voltage vehicle electrical system 2 which uses a nominal voltage of 42 Volts or 48 Volts, for example, as well as a normal voltage vehicle electrical system 3 which uses a nominal voltage of 12 Volt. High-voltage vehicle electrical system 2 and normal voltage vehicle electrical system 3 are in electrical connection with each other via a voltage transformer 4. Depending on the instantaneous operating state of high-voltage vehicle electrical system 2 or normal voltage vehicle electrical system 3, voltage transformer 4 is without function (switched off), withdraws current from normal voltage vehicle electrical system 3 and converts it to the higher operating voltage of high-voltage vehicle electrical system 2, or it withdraws current from high-voltage vehicle electrical system 2 and converts it to the lower voltage level of normal voltage vehicle electrical system 3. For voltage converter 4, one (or more) interrupter switch(es) 5 may be provided in order to electrically separate high-voltage vehicle electrical system 2 and normal voltage vehicle electrical system 3 in a reliable manner. Interrupter switch(es) 5 may, of course, also be developed as electronic switches, such as transistors, thyristors, triacs, or the like.

Normal voltage vehicle electrical system 3 is shown only schematically here. In connection with normal voltage vehicle electrical system 3, an alternator, a starter, vehicle electronics, lighting devices, electrical heaters, ignition systems, fuel-injection systems, ventilators, and a vehicle battery may be provided.

High-voltage vehicle electrical system 2 shown in FIG. 1 has a high-voltage battery unit 6, in which a high-voltage battery 7 and an electrical contactor 8 are developed as an integral unit. Electrical contactor 8 has three different interrupter switches 9a, 9b, 9c, which are looped into three different line branches 10a, 10b, 10c. Line branch 10c corresponds to the ground line. High-voltage battery 7 may also be electrically separated from the rest of vehicle electrical system 1 in potential-free manner via interrupter switches 9a, 9b, 9c. Line branch 10a corresponds to the voltage pole (positive pole) of high-voltage battery 7. In addition, a line branch 10b is provided into which a series resistor 11 is looped. At a very low charge state of high-voltage battery 7, this line branch 10b having series resistor 11 may be selected in order to avoid an excessive charge current, which might damage high-voltage battery 7.

Furthermore, an electric drive motor 12 is provided in high-voltage vehicle electrical system 2, by which hybrid vehicle 15 is able to be driven at least partially. For this purpose, drive motor 12 withdraws corresponding electrical power from high-voltage vehicle electrical system 2. If hybrid vehicle 15 is decelerated, then drive motor 12 is operated as an electrical generator. This converts the kinetic energy of hybrid vehicle 15 into electrical energy, which is able to be temporarily stored in high-voltage battery unit 6 (recuperation operation). The electrical energy stored there may be used later on, for example for accelerating hybrid vehicle 15 again.

In addition, a generator 13 is provided in high-voltage vehicle electrical system 2. For instance, electrical generator 13 is mechanically connected to the crankshaft of an internal combustion engine (not shown here). If hybrid vehicle 15 is moved at a constant driving speed with the aid of the internal combustion engine, for instance, then unused mechanical driving power of the internal combustion engine is usually available. This unused mechanical driving power of the internal combustion engine may be converted into electrical energy with the aid of generator 13 and temporarily stored in high-voltage battery unit 6. This makes it possible to operate the internal combustion engine in a speed and torque range that is particularly energy-efficient, so that hybrid vehicle 15 requires less fuel when viewed over a longer period of time.

Finally, a test resistor 14 can be seen in high-voltage vehicle electrical system 2 of vehicle electrical system 1, via which high-voltage vehicle electrical system 2 (and also high-voltage battery 7 given a corresponding switch position of interrupter switches 9a, 9b, 9c of electrical contactor 8) may be loaded with a defined electrical load. In addition or as an alternative, it is also possible for drive motor 12 and/or voltage converter 4 (possibly also additional electrical consumers) to serve as electrical load.

As shown in FIG. 1, various measuring points 16, 17, 18, 19 are provided in high-voltage vehicle electrical system 2. Measuring point U₀ (18) corresponds to the electrical voltage level of ground line branch 10c of high-voltage battery unit 6. Measuring connection U₁ (16) corresponds to the voltage level of the positive pole of high-voltage battery 7. Measuring connection U₂ (17) corresponds to the voltage level of electrical consumers 4, 12, 14 or electrical energy sources 4, 12, 13 connected to high-voltage vehicle electrical system 2. Furthermore, a measuring point I₁ (19) is provided via which the high-voltage battery current is able to be acquired, that is to say, the current by which high-voltage battery unit 6 is charged or discharged. The measured values are able to be supplied to an electronic control circuit 20, which is only shown schematically in this case and which monitors the operating state of high-voltage vehicle electrical system 2. In particular, control circuit 20 also has the capability of controlling interrupter switches 9a, 9b, 9c as well as voltage converter 4.

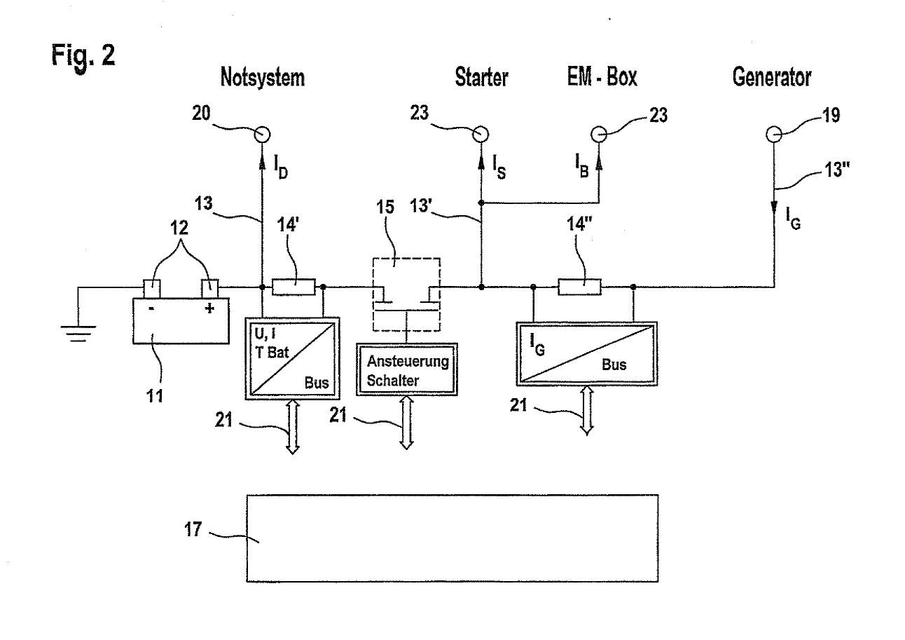

When electrical contactor 8 of high-voltage battery unit 6 (FIG. 1) is open, different measuring results may be obtained, each measuring result indicating a defect of electrical contactor 8. Such a defect may be due to the fact that one (or more) interrupter switch(es) 9a, 9b, 9c is/are not closed, or that the contact surfaces of the individual switches 9a, 9b, 9c have contact difficulties (because they exhibit scaling, for example). A selection of measuring results indicating such a fault is shown in FIG. 2 (subfigures 2a, 2b, 2c, 2d). In FIG. 2, time t is plotted on abscissa 21, and the measured value of one of measuring points 16, 17, 18, 19 is plotted on ordinate 22.

For example, if the voltage of high-voltage battery 7, U₁ (16), and voltage U₂ (17) applied at the electrical consumers or energy-supply devices 4, 12, 13, 14, deviate considerably from each other (FIG. 2a) in the closed state of electrical contactor 8 (interrupter switches 9a, 9c, and possibly also 9b are closed), then this points to a defect of electrical contactor 8.

A defect of electrical contactor 8 is also indicated if battery current I₁ (19) remains at a low level in the closed state of electrical contactor 8, despite the fact that electrical consumers 4, 12, 14, or electrical energy-supply units 4, 12, 13 are switched on at this point in time. It should be noted that battery current I₁ (19) is signed (charging/discharging of high-voltage battery unit 6).

Another signal is shown in FIG. 2c. Here, too, a defect of electrical contactor 8 is indicated if despite a closed electrical contactor 8, high-voltage battery voltage U₁ (16) and high-voltage vehicle electrical output voltage U₂ (17) begin to deviate considerably from each other when one or more electrical consumer(s) 4, 12, 14 is/are switched on at a switching instant t₀ (23).

FIG. 2d illustrates the potential effect of a defective electrical contactor 8 when electrical contactor 8 is closed and when one or more energy-supply device(s) 4, 12, 13 is/are switched on at a switching instant t₀ (23). Despite electrical contactor 8 being closed, high-voltage vehicle system voltage U₂ (17) may then rise in relation to high-voltage battery voltage U₁ (16).

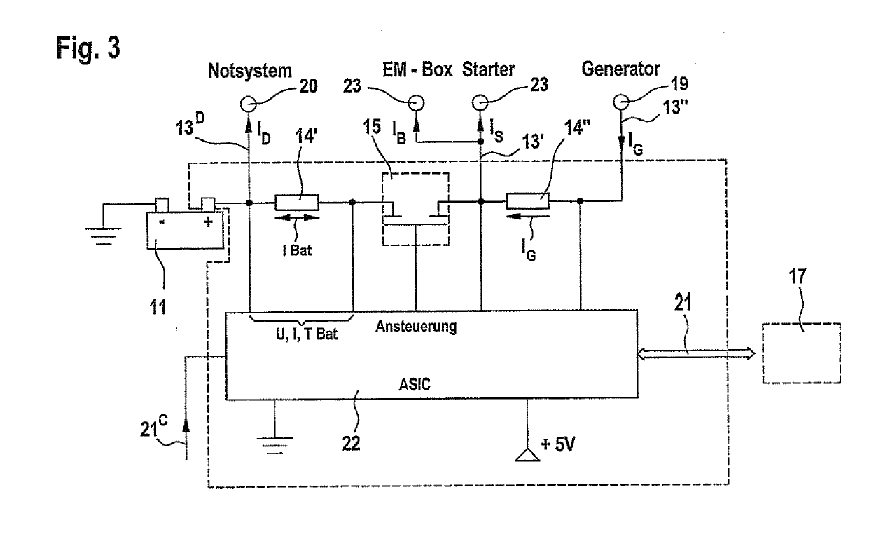

In FIG. 3 the already illustrated vehicle electrical system 1 of a hybrid vehicle 15 is shown. In contrast to vehicle electrical system 1 shown in FIG. 1, electrical contactor 8 of high-voltage battery unit 6 is open in vehicle electrical system 1 shown in FIG. 3. Interrupter switches 9a, 9b, 9c of electrical contactor 8 have been brought into the interrupt switching position for this purpose.

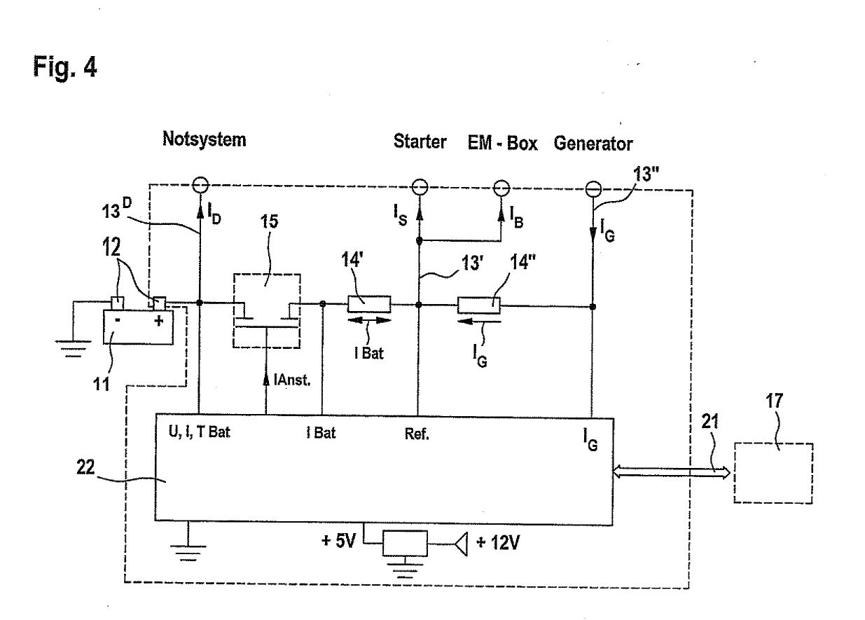

In the event that due to a switching operation of electrical contactor 8 under load, for example, its electrical contacts are stuck to each other, then an at least partial electrical connection may be established between high-voltage battery unit 6 and the other components 4, 12, 13, 14 of high-voltage vehicle electrical system 2, despite an open contactor 8. Typical current or voltage curves are produced as a result, in particular at measuring points 16, 17, 18, 19, which point to a defect of electrical contactor 8. A selection of such current or voltage curves indicating an electrical defect of contactor 8 is shown in FIG. 4. Individual measured values are shown in subfigures 4a, 4b, 4c, 4d of FIG. 4. Temporal characteristic t is shown along abscissa 21, and the quantity of corresponding measuring point 16, 17, 18, 19 is shown along ordinate 22.

For example, if—as shown in FIG. 4a, for example—high-voltage battery voltage U₁ (16) and high-voltage vehicle electrical system output voltage U₂ (17) stay generally the same despite an open contactor 8, regardless of the loading of high-voltage vehicle electrical system 2 by electrical consumers 4, 12, 14, or by electrical supply devices 4, 12, 13, then this points to an electrical contactor 8 that is no longer able to open (completely).

A fault of electrical contactor 8 is also indicated when a battery current I₁ (19) of significant magnitude remains despite an open contactor 8, as shown in FIG. 4b.

Generally, a fault of electrical contactor 8 also exists when high-voltage battery voltage U₁ (16) and high-voltage vehicle system output voltage U₂ (17) remain at the same level (cf. FIG. 4c or FIG. 4d), despite an electrical consumer 4, 12, 14 being switched on in high-voltage vehicle electrical system 2 at a switching instant t₀ (23), or an electrical energy supply device 4, 12, 13 being switched on in electrical high-voltage vehicle electrical system 2.

1-10. (canceled)

11. A vehicle electrical system for a motor vehicle comprising:
a first vehicle electrical system having at least one of: i) at least one electrical consumer connected to it, and ii) at least one electrical energy generation device connected to it, the first vehicle electrical system further having at least one energy accumulator and at least one switching device monitor connected to it, the energy accumulator being able to be separated from the first vehicle electrical system via a switching device, and the at least one switching device monitor configured to check an operating state of the switching device.

12. The vehicle electrical system as recited in claim 11, wherein the vehicle electrical system has the at least one electrical consumer connected to it, at least one of the electrical consumers being an electrical drive motor capable of being operated as an electrical generator intermittently.

13. The vehicle electrical system as recited in claim 11, wherein the first vehicle electrical system has at least one electrical energy generation device connected to it, at least one of the electrical energy generation devices being an electrical generator which is capable of being driven by an internal combustion engine.

14. The vehicle electrical system as recited in claim 11, wherein the switching device is capable of assuming at least two switching states.

15. The vehicle electrical system as recited in claim 11, wherein the switching device is capable of assuming at least three switching states.

16. The vehicle electrical system as recited in claim 11, wherein at least one of the switching device monitors is a performance test device and has performance test loads.

17. The vehicle electrical system as recited in claim 11, wherein at least one of the switching device monitors is a supply test device and has supply test sources.

18. The vehicle electrical system as recited in claim 11, wherein at least one of the switching device monitors has at least one measuring device, the at least one measuring device being selected from the group consisting of current measuring devices, voltage measuring devices, voltage-differential measuring devices, voltage-characteristic measuring devices, and current-characteristic measuring devices.

19. The vehicle electrical system as recited in claim 11, further comprising:
at least one second vehicle electrical system, which has a different nominal voltage than the first vehicle electrical system.

20. A hybrid motor vehicle, comprising:
a first vehicle electrical system having at least one of: i) at least one electrical consumer connected to it, and ii) at least one electrical energy generation device connected to it, the first vehicle electrical system further having at least one energy accumulator and at least one switching device monitor connected to it, the energy accumulator being able to be separated from the first vehicle electrical system via a switching device, and the at least one switching device monitor configured to check an operating state of the switching device.

21. A method for checking an operating state of an electrical switching device, which connects an electrical energy accumulator to a vehicle electrical system in a reversible manner, the method comprising at least one of:
determining the operating state by measuring a temporal characteristic of at least a voltage;
determining the operating state by measuring a temporal characteristic of at least a current intensity; and
determining the operating state by measuring the electrical current flowing through the switching device and measuring a voltage differential across the switching device.
